(19) United States
(12) Patent Application Publication
(10) Pub. No.: US 2001/0053701 A1
(43) Pub. Date: Dec. 20, 2001

(54) Communication device

(76) Inventor: Masakazu Hattori, Kanagawa (JP)

Correspondence Address: FROMMER LAWRENCE & HAUG LLP, 745 FIFTH AVENUE, NEW YORK, NY, 10151, US

(21) Appl. No.: 09/834,293

(22) Filed: Apr. 12, 2001

(30) Foreign Application Priority Data
Apr. 13, 2000 (JP) 2000-117224

(51) Int. Cl. H04M 1/00

(52) U.S. Cl. 455/550; 455/559

(57) ABSTRACT

Radio communication is performed by using a function card, and other functions can be added to a host device. The communication device is installed to a card slot of the host device such as a PC operated by the user, and a small memory card is installed to the communication device. The memory card stores a communication application program to be installed to the host device and communication information for controlling communication at the baseband processing unit 42. When a card-shaped radio communication device 20 controls radio communication between a host device 10 and a radio communication network, the communication application program is installed to the host device 10, and the baseband processing unit 42 is controlled by the use of the communication information. Thus, the radio communication between the host device 10 and radio communication network is performed.

### BACKGROUND OF THE INVENTION

1. Field of the Invention

The present invention relates to a communication device for controlling communication of a host device using a radio telecommunication line, to which a card is installed.

2. Description of Related Art

Conventionally, a host device such as a personal computer (PC) or personal digital assistant (PDA) usually has a card installation portion (a card slot) to which a function card having various functions is installed. The host device can use the function card installed to the card installation portion thereof as an external memory. In case the function card has a communication function internally, the host device can add the communication function when the function card is installed to the card installation portion of the host device. In case the function card conforms to a communication protocol corresponding to a telecommunication line network such as the LAN (Local Area Network), wireless telephone apparatus, modem, radio LAN, the host device can add the communication function using the telecommunication line network.

However, the host device usually cannot use the function card by only installing the function card having the communication function to the card installation portion. That is, the host device such as the PC or PDA needs to have an application program capable of using the communication function owned by the function card. Such an application program has to be installed to the host device by using a CD-ROM, or via a network.

Furthermore, the host device usually has only one card installation portion in view of reduction of cost and reduction in size. In this case, the function card having the communication function and the function card having a memory function cannot be used simultaneously.

### SUMMARY OF THE INVENTION

It is therefore an object of the present invention to overcome the above-mentioned drawbacks by providing a communication device which can perform radio communication by using the function card, and can add other functions to the host device. That is, the object of the present invention is that communication information necessary in performing communication is stored in a card, which enables communication with other persons by exchanging the card.

According to the present invention, there is provided a communication device, including:

a first connection means for transmitting/receiving data to/from a first electronic device which has a storage unit having at least communication information related to communication using a radio communication network stored therein in accordance with a first system;

a second connection means for transmitting/receiving data to/from a second electronic device in accordance with a second system;

a communication control instruction reception means for receiving communication control instructions sent from the second electronic device via the second connection means;

a first communication information extraction means for extracting and storing first communication information necessary for a radio communication means from the data received via the first connection means; and

a radio communication means for performing communication between the second electronic device and other electric devices included in the radio communication network by the use of the first communication information extracted by the first communication information extraction means.

With the communication device according to the present invention, the communication information stored in the first electronic device is read out and sent to the radio communication means, and a communication application program stored in the first electronic device is read out and sent to the second electronic device, and communication is performed between the second electronic device and other electric devices included in the radio communication network. Thus, even though the second electronic device does not have the communication function, the communication device can add communication function to the second electronic device by reading out the communication application program and sending the program to the second electronic device at the time of performing communication.

That is, according to the present invention, since the first communication information necessary in making connections with other electric devices is stored in a card, radio communication with other persons can easily be realized by only exchanging the card.

These objects and other objects, features and advantages of the present intention will become more apparent from the following detailed description of the preferred embodiments of the present invention when taken in conjunction with the accompanying drawings.

### BRIEF DESCRIPTION OF THE DRAWINGS

FIG. 1 shows a block diagram showing the configuration of a communication system which employs the present invention.

FIG. 2 shows a block diagram showing the configuration of a card-shaped radio communication device which employs the present invention.

FIG. 3 shows the configuration of data stored in the storage unit of the card-shaped memory.

FIG. 4 shows the arrangement of the connection terminals of the card-shaped radio communication device which employs the present invention.

FIG. 5 shows a block diagram showing the configuration of a card-shaped memory which employs the present invention.

FIGS. 6A and 6B show a front view and a rear view of the card-shaped memory.

FIG. 7 shows an enlarged view of a signal inputting/outputting unit of the card-shaped memory.

FIG. 8 shows an explanation view of arrangement of the connection terminals of the card-shaped memory.

### DESCRIPTION OF THE PREFERRED EMBODIMENTS

Preferred embodiments according to the present invention will further be described below with reference to the accompanying drawings.

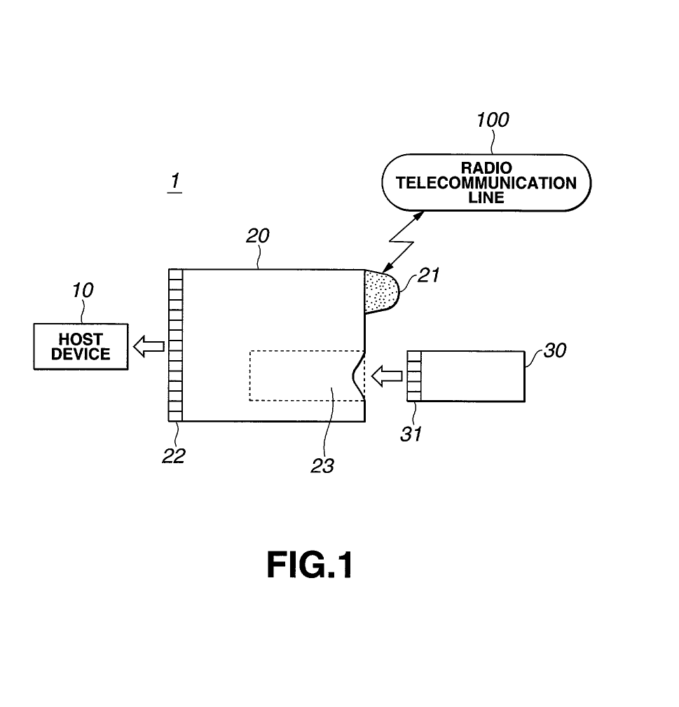

FIG. 1 shows a block diagram of a communication system 1, and the present invention will be applied to this communication system 1.

As schematically shown in FIG. 1, the communication system 1 includes a host device 10 operated by the user, a card-shaped radio communication device 20 connected to the host device 10 via a line, a card-shaped memory 30 connected to the card-shaped radio communication device 20 via a line. The card-shaped radio communication device 20 of the communication system 1 communicates with other electric devices included in a radio telecommunication line 100 in accordance with, for example, the so-called Bluetooth system.

The Bluetooth system is the name of a short-range radio communication technique whose standardization is initiated by five Japanese and European companies in May, 1998. The Bluetooth system builds a short-range radio communication network having the maximum transmission distance of approximately 10 m, in which data is transmitted at the maximum velocity of 1 Mbps (effectively, 723 Kbps). In the Bluetooth system, 79 channels each having a bandwidth of 1 MHz are set up in the ISM (Industrial Scientific Medical) frequency band of 2.4 GHz band which can be used without permission, and the spread spectrum communication technique of the frequency hopping system which switches the channels 1600 times per second is employed to transmit/receive radio waves between the host devices 10.

And, the master/slave system is applied to each of the host devices 10 included in the short-range radio communication network employing the Bluetooth system. Each of the host devices 10 is either a master device which determines the frequency hopping pattern in accordance with the processing contents, or a slave device which is controlled by the master device. The master device can communicate with seven slave devices simultaneously. A subnet consisting of one master device and seven slave devices is termed a “piconet”. A host device 10 as a slave device included in the piconet, or the radio telecommunication line 100, can be a slave device of two or more piconets simultaneously.

The host device 10 is an electronic device which is mechanically connected to the card-shaped radio communication device 20, and is operated by the user. The host device 10 is, for example, a personal computer, PDA (Personal Digital Assistant), digital camera, mail processing terminal or EMD (Electric Music Distribution).

The host device 10 has a serial interface to make a connection with the card-shaped radio communication device 20, and the card-shaped radio communication device 20 can be mechanically installed/detached to/from a concave installation portion of the host device 10 having the serial interface.

The concave installation portion of the host device 10 has signal input/output terminals consisting of communication terminals and memory terminals. The host device 10 sends/receives data to/from the card-shaped radio communication device 10 via these communication terminals and memory terminals.

The host device 10 has an interface function conforming to a second system different from a first system which will be described later, and sends/receives data to/from the card-shaped radio communication device 20 installed to the concave installation portion thereof in accordance with the second system. The second system to which the interface function of the host device 10 conforms is, for example, the PCMCIA (Personal Computer Memory Card International Association) standard.

The card-shaped radio communication device 20 is a function card which communicates with other electric devices included in the external radio telecommunication line 100. The card-shaped radio communication device 20 has a radio antenna 21 to transmit/receive radio data to/from other electric devices included in the radio telecommunication line 100.

The card-shaped radio communication device 20 also has an interface function conforming to the second system which is identical to that of the host device 10. The card-shaped radio communication device 20 has connection terminals 22 which are installed to the concave installation portion of the host device 10. Thus, the card-shaped radio communication device 20 is mechanically connected to the host device 10, and sends/receives data to/from the host device 10.

The connection terminals 22 has, for example, 64 terminals. Of the 64 terminals, some terminals may be communication terminals and the other terminals may be memory terminals. The connection terminals 22 sends/receives data based on the PCMCIA standard.

The card-shaped radio communication device 20 has a concave installation portion 23 to which the card-shaped memory 30 is installed. Thus, the card-shaped memory 30 is mechanically connected to the card-shaped radio communication device 20. The card-shaped radio communication device 20 also has an interface function conforming to a first system different from the second system, and sends/receives data to/from the card-shaped memory 30 in accordance with the first system.

The first system to which the card-shaped radio communication device 20 conforms is, for example, the Compact Flash standard, Memory Stick standard, Smart Media standard, or SD card standard.

The card-shaped memory 30 is a function card having a memory function internally. The card-shaped memory 30 has an interface function conforming to the first system different from the second system, and sends/receives data to/from the card-shaped radio communication device 20. The card-shaped memory 30 has connection terminals 31 which are installed to the concave installation portion 23 of the card-shaped radio communication device 20. Thus, the card-shaped memory 30 is mechanically connected to the card-shaped radio communication device 20, and sends/receives data to/from the card-shaped radio communication device 20.

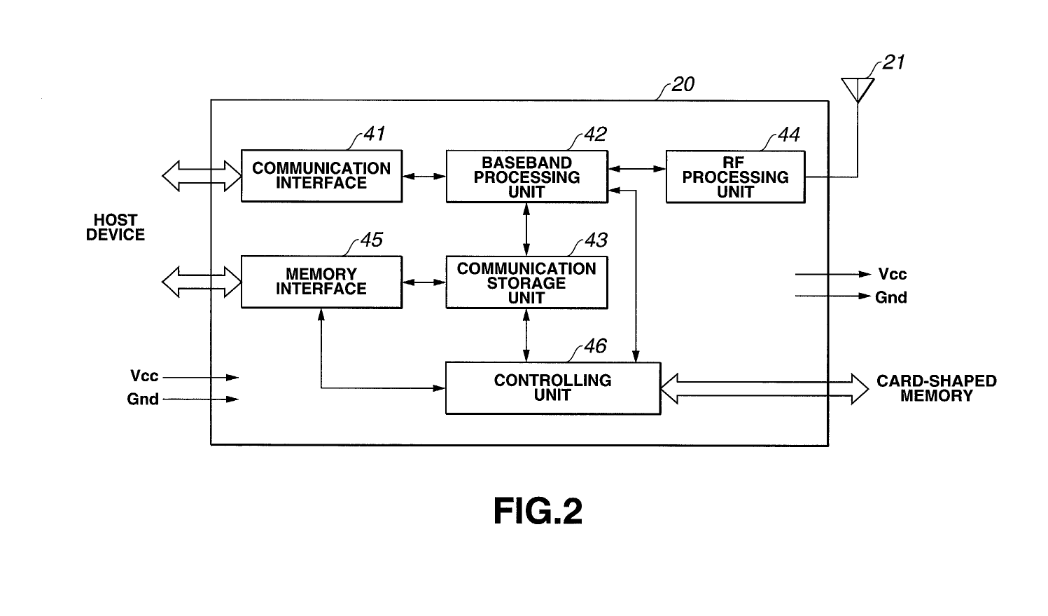

Next, the configuration of the card-shaped radio communication device 20 will be explained with reference to FIG. 2.

As shown in FIG. 2, the card-shaped radio communication device 20 includes a communication interface 41 to be connected to the communication terminals of the host device 10, a baseband processing unit 42, a communication storage unit 43, an RF (Radio Frequency) processing unit 44, a memory interface 45, and a controlling unit 46, and those components are housed in a card-shaped housing.

The card-shaped radio communication device 20 has mainly two systems. One of the systems is for radio communication, which includes the communication interface 41, baseband processing unit 42, and RF processing unit 44. The other of the system is for processing between the card-shaped memory 30 installed to the concave installation portion 23, which includes the memory interface 45 and controlling unit 46.

The radio antenna 21 detects radio data of a frequency band used by the radio telecommunication line 100, and transmits radio data to the radio telecommunication line 100. When the radio telecommunication line 100 conforms to the BT system, the radio antenna 21 transmits/receives radio data of 2.4 GHz band.

The radio antenna 21 is connected to the RF processing unit 44, and the RF processing unit 44 is connected to the baseband processing unit 42. The RF processing unit 44 detects analog signals from radio data received by the radio antenna 21 and A/D (analog to digital) converts the analog signal. At this time, the RF processing unit 44 receives radio data in accordance with the frequency hopping in 2.4 GHz band.

The RF processing unit 44 D/A (digital to analog) converts the digital data from the baseband processing unit 42, and sends analog signals to the radio antenna 21 by the use of carrier waves of 2.4 GHz band. At this time, the RF processing unit 44 sends radio data to the radio antenna 21 in accordance with the frequency hopping in 2.4 GHz band.

The baseband processing unit 42 is connected to the RF processing unit 44, communication interface 41, communication storage unit 43 and controlling unit 46. The baseband processing unit 42 performs error detection and error correction for data from the RF processing unit 44 and sends a request to resend data under control signals from the controlling unit 46.

When transmitting radio data from the card-shaped radio communication device 20 to the radio telecommunication line 100 via the radio antenna 21, the baseband processing unit 42 adds codes for error detection, codes for error correction, and header information for controlling communication to the radio data.

Furthermore, when receiving radio data from the radio telecommunication line 100 via the radio antenna 21, the baseband processing unit 42 decodes data which is encoded in a predetermined manner. In case the received data is encoded based on the MPEG 4 standard, the baseband processing unit 42 decodes the data based on the MPEG 4 standard.

Furthermore, when transmitting/receiving radio data in accordance with the BT system, the baseband processing unit 42 performs radio communication link control such as authentication with other host devices included in the radio telecommunication line 100 and encryption of data. When performing the authentication and encryption processing, the baseband processing unit 42 reads out inherent ID information of host devices which perform radio communication, device information of devices to which radio data will be transmitted, personal information related to the user of the host device 10, and password information necessary in performing authentication processing from the communication storage unit 43.

The communication storage unit 43 has a memory capacity necessary for performing above-described processing at the baseband processing unit 42. The communication storage unit 43 is, for example, a RAM (Random Access Memory), and have a memory capacity of 32 kB or 64 kB.

The communication interface 41 has above-described communication terminals, and the card-shaped radio communication device 20 is installed to the concave installation portion of the host device 10. Thus, the communication interface 41 is connected to the communication terminals of the host device 10, and communication signals are transmitted/received in accordance with the second system.

When outputting radio data received via the radio antenna 21 to the host device 10, the communication interface 41 converts the data from the baseband processing unit 42 to a data format in accordance with the second system, and outputs the data to the host device 10 via the communication terminals.

When transmitting the data from the host device 10 to other host devices included in the radio telecommunication line 100 via the radio antenna 21, the communication interface 41 converts the data from the host device 10 to a data format capable of being processed by the baseband processing unit 42.

The memory interface 45 has the memory terminals, and the card-shaped radio communication device 20 is installed to the concave installation portion of the host device 10. Thus, the memory interface 45 is connected to the memory terminals of the host device 10, and memory signals are transmitted/received in accordance with the second system.

When storing data from the host device 10 in the card-shaped memory 30, the memory interface 45 stores data received in accordance with the second system in the communication storage unit 43, and specifies a storage address for writing the data to the card-shaped memory 30.

When a readout instruction for reading out data from the card-shaped memory 30 and sending the data to the host device 10 is received, the memory interface 45 outputs a signal indicating about this to the controlling unit 46, and converts the data read out and sent to the communication storage unit 43 to a data format in accordance with the second system, and outputs the data to the host device 10.

The controlling unit 46 manages data to be stored in the card-shaped memory 30, by controlling the memory interface 45 and communication storage unit 43.

When the card-shaped memory 30 is installed to the concave installation portion 23, the controlling unit 46 has accesses to the data stored in the storage unit 52 of the card-shaped memory 30 in accordance with the first system, and writes the data read out from the card-shaped memory 30 to the communication storage unit 43. The controlling unit 46 writes the data stored in the communication storage unit 43 from the host device 10 via the memory interface 45 to a specified address in the card-shaped memory 30.

The switching over of writing and reading out of data for the memory in the card-shaped memory 30 and specification of a storage address performed by the controlling unit 46 is controlled by a control signal from the host device 10 transmitted via the memory interface 45.

The controlling unit 46 controls the communication processing system of the card-shaped radio communication device 20 by controlling the processing performed by the baseband processing unit 42. When the host device 10 communicates with other host devices included in the radio telecommunication line 100, the controlling unit 46 reads out a communication application program stored in a storage unit 52 which will be described later, and sends the program to the host device 10 to install the program thereto. The controlling unit 46 also reads out communication information stored in the storage unit 52, and sends the communication information to the communication storage unit 43. Then, the controlling unit 46 controls the baseband processing unit 42 so that communication is performed by the use of the communication information stored in the communication storage unit 43. Thus, the host device 10 communicates with other host devices included in the radio telecommunication line 100. The controlling unit 46 reads out addresses of radio communication devices to be communicated with, functional information owned by the radio communication devices, password information necessary in performing radio communication from the card-shaped memory 30 as the communication information.

It depends on the format of the data whether the baseband processing unit 42 in the card-shaped radio communication device 20 uses the data stored in the storage unit 52 of the card-shaped memory 30, or the host device 10 reads out the data and uses it.

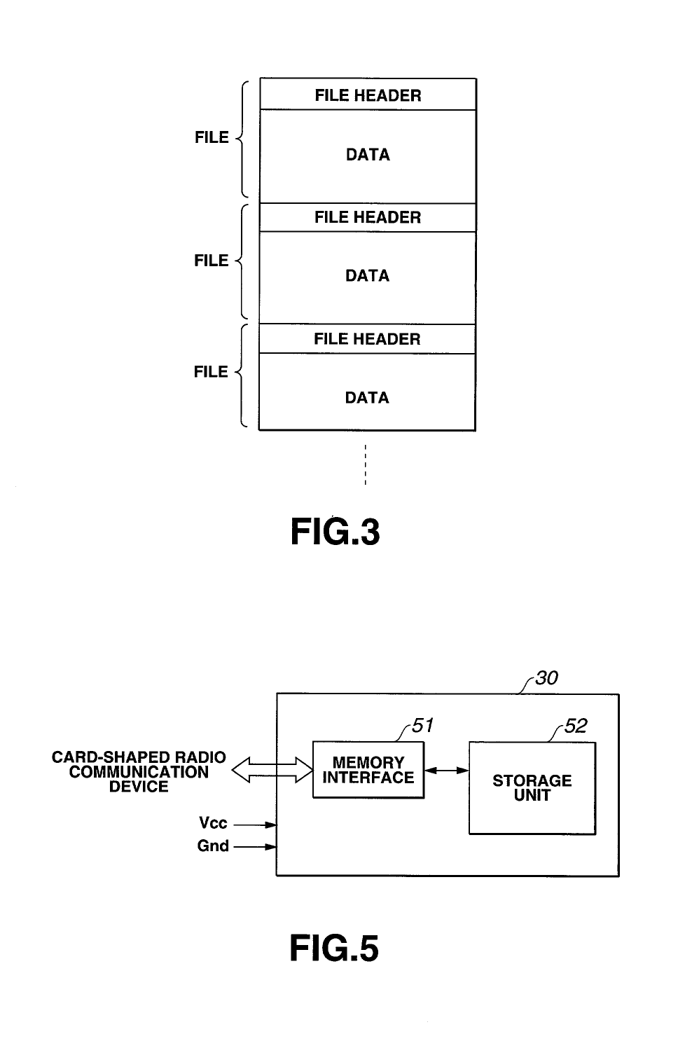

As shown in FIG. 3, the data stored in the storage unit 52 of the card-shaped memory 30 consists of files, and a file is made up of a file header and data.

The file header has a file name, file type, additional information dependent on the file type, and data size.

When the card-shaped memory 30 is installed to the card-shaped radio communication device 20, the controlling unit 46 of the card-shaped radio communication device 20 checks the type of files included in the card-shaped memory 30.

The controlling unit 46 reads out only file headers written in the card-shaped memory 30 by skipping data based on the data sizes included in the file headers.

The file type included in the file header has communication information for the card-shaped radio communication device 20, communication information for the host device 10, communication application program for the host device 10, and other data for the host device 10.

After checking the type of files included in the card-shaped memory 30, when there exists information to be used in the card-shaped radio communication device 20, the controlling unit 46 reads out the information and writes it to a predetermined position in the communication storage unit 43 and outputs a signal about this to the baseband processing unit 42.

On the other hand, after checking the type of files included in the card-shaped memory 30, when there exists information to be used in the host device 10, the controlling unit 46 informs the host device 10 of the existence of the card-shaped memory 30 via the memory interface 45 connecting the card-shaped radio communication device 20 and host device 10.

The host device 10, which is informed of the existence of the card-shaped memory 30, sends a control signal to the card-shaped radio communication device 20 via the memory interface 45, and reads out data in the card-shaped memory 30 by way of the controlling unit 46, communication storage unit 43, and memory interface 45.

The host device 10 supplies a power signal Vcc and a ground signal Gnd to the card-shaped radio communication device 20. Furthermore, the controlling unit 46 supplies the power signal Vcc and ground signal Gnd to the card-shaped memory 30 installed to the concave installation portion 23 of the card-shaped radio communication device 20.

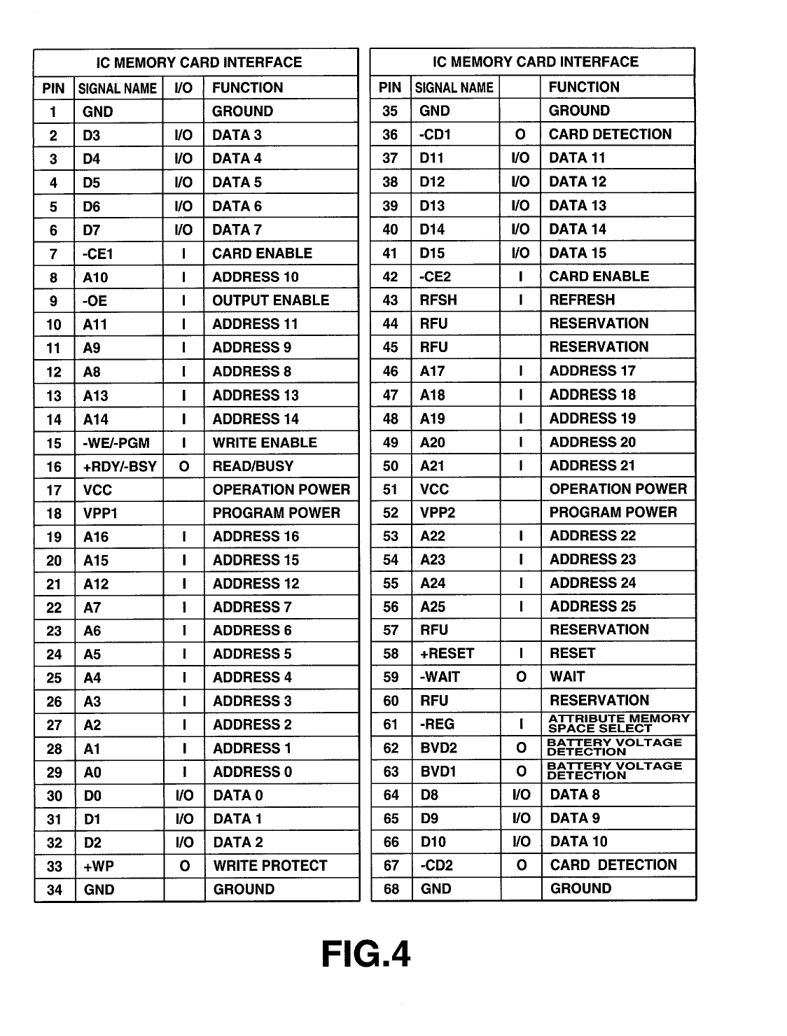

The arrangement of the connection terminals 22 of the card-shaped radio communication device 20 will be explained with reference to FIG. 4.

As shown in FIG. 4, 17th pin and 51st pin are assigned for the power, and 1st pin, 34th pin, 35th pin, and 68th pin are assigned for the ground.

As data pins for transmitting/receiving data between the card-shaped radio communication device 20 and the host device 10, 30th pin, 31st pin, and 32nd pin are assigned for data 0, data 1, and data 2, respectively. Similarly, 2nd pin, 3rd pin, 4th pin, 5th pin, and 6th pin are assigned for data 3, data 4, data 5, data 6, and data 7, respectively. And, 64th pin, 65th pin, and 66th pin are assigned for data 8, data 9, and data 10, respectively. And, 37th pin, 38th pin, 39th pin, 40th pin, and 41st pin are assigned for data 11, data 12, data 13, data 14, and data 15, respectively.

Furthermore, as address pins, 29th pin, 28th pin, 27th pin, 26th pin, 25th pin, 24th pin, 23rd pin, and 22nd pin are assigned for address 0, address 1, address 2, address 3, address 4, address 5, address 6, and data 7, respectively. Similarly, 12th pin, 11th pin, 8th pin, 10th pin, 21st pin, 13th pin, 14th pin, 20th pin, and 19th pin are assigned for address 8, address 9, address 10, address 11, address 12, address 13, address 14, address 15, and address 16, respectively. And, 46th pin, 47th pin, 48th pin, 49th pin, 50th pin, 53rd pin, 54th pin, 55th pin, and 56th pin are assigned for address 17, address 18, address 19, address 20, address 21, address 22, address 23, address 24, and address 25, respectively.

The memory interface 45 transmits/receives signals which specify storage addresses for data to be stored in the storage unit 52 by the use of the address pins. The communication interface 41 transmits/receives data and each type of signals which utilize the radio communication function of the card-shaped radio communication device 20 by the use of some of the data pins. The memory interface 45 transmits/receives data and each type of signals which utilizes the memory function of the card-shaped memory 30 by the use of pins other than those used by the communication interface 41.

The configuration of the card-shaped memory 30 will be explained with reference to FIG. 5.

The card-shaped memory 30 has a memory interface 51 and a storage unit 52.

As described above, the memory interface 51 has the connection terminals 31. When the card-shaped memory 30 is installed to the concave installation portion 23 of the card-shaped radio communication device 20, the connection terminals 31 are connected to those of the concave installation portion 23 and signals are transmitted/received. The memory interface 51 controls transmission/reception of data between the card-shaped memory 30 and card-shaped radio communication device 20 under the readout instruction and writing instruction from the controlling unit 46 in accordance with the first system, and manages the transmission/reception of signals between the card-shaped memory 30 and host device 10 via the card-shaped radio communication device 20.

When the readout instruction is sent to the memory interface 51 from the card-shaped radio communication device 20, the memory interface 51 reads out data from a specified storage address in the storage unit 52, and sends the read out data to the card-shaped radio communication device 20.

When the writing instruction is sent to the memory interface 51 from the card-shaped radio communication device 20, the memory interface 51 writes data to a specified storage address in the storage unit 52.

The storage unit 52 is, for example, a flash memory or EEROM, and stores user data (information necessary in having accesses to service obtained from the communication devices to be communicated with, for example, user name and password information) used by the host device 10, installation program for adding functions to the host device 10, communication application program for utilizing the communication function of the card-shaped radio communication device 20, and communication information necessary for the card-shaped radio communication device 20 to be connected to other communication devices. The communication information is such as inherent ID information of host devices which perform radio communication, device information of devices to which radio data will be transmitted (for example, addresses of communication devices to be communicated with), personal information related to the user of the host device 10, and authentication information necessary in performing authentication processing with communication devices to be communicated with.

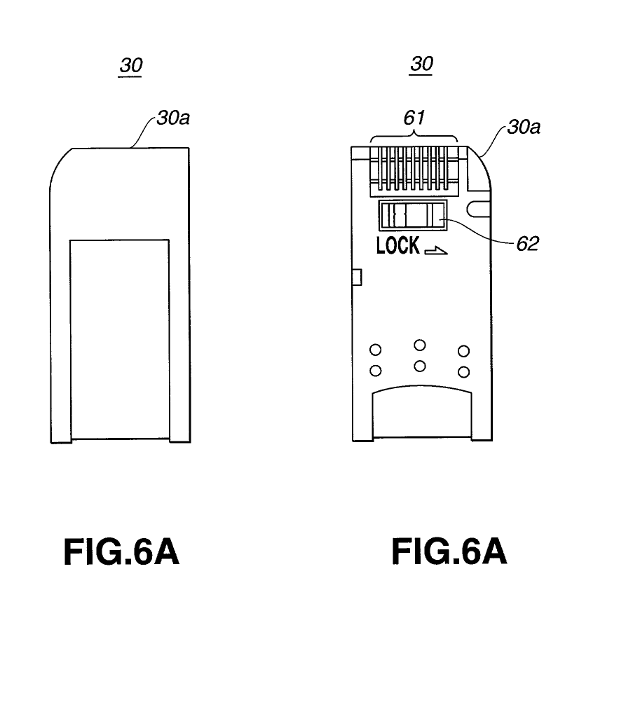

FIGS. 6A and 6B show schematic views of the card-shaped memory 30. The width, length and thickness of the card-shaped memory 30 is, for example, 2.5 mm, 50.0 mm and 2.8 mm, respectively. Specifically, FIGS. 6A and 6B show a front view and rear view of the card-shaped memory 30, respectively. One end 30a of the card-shaped memory 30 is inserted to the concave installation portion 23 of the card-shaped radio communication device 20. Thus, the card-shaped memory 30 is mechanically connected to the card-shaped radio communication device 20, and data is transmitted/received between them.

The rear side of the card-shaped memory 30 has a signal inputting/outputting unit 61, and a mis-erasing preventive unit 62 for performing switching over of writing data possible and writing data impossible at the side of the end 30a. The signal inputting/outputting unit 61 has ten terminals, and data is transmitted/received between the card-shaped memory 30 and card-shaped radio communication device 20 via each of the terminals.

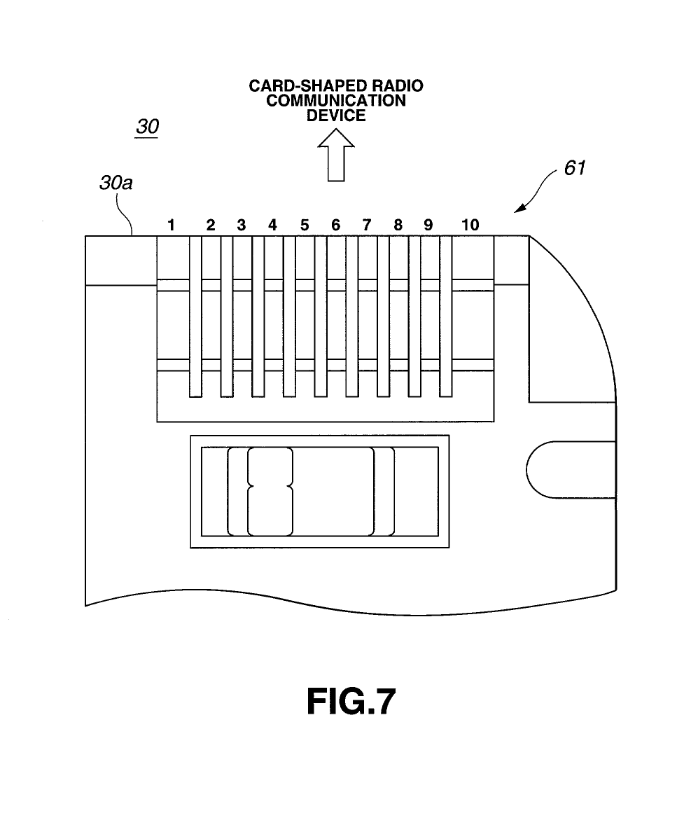

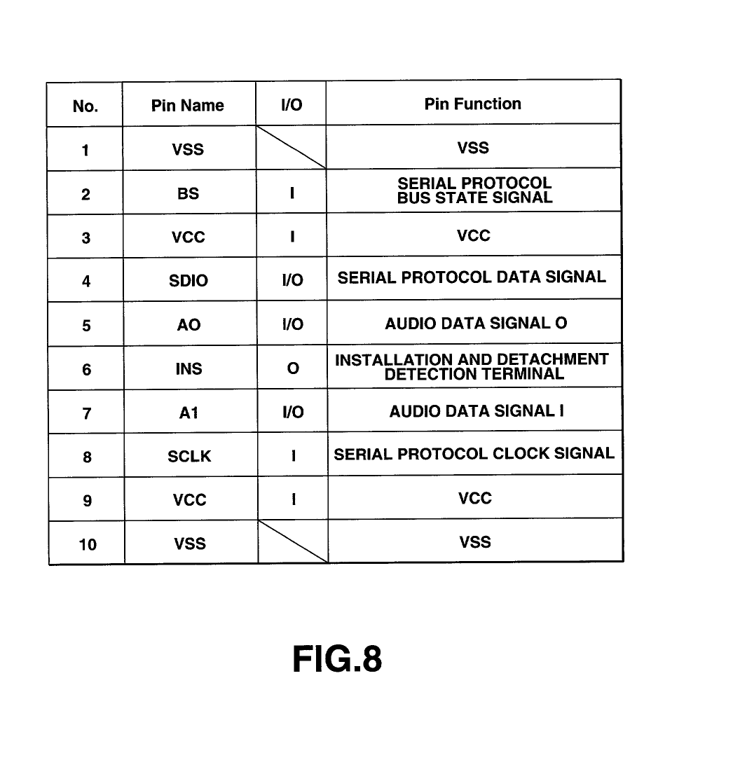

FIG. 7 shows an enlarged view of the signal inputting/outputting unit 61. As shown in FIG. 7, the ten terminals of the signal inputting/outputting unit 61 are numbered from 1 to 10. FIG. 8 shows an explanation view of arrangement of the connection terminals of the card-shaped memory 30. The connection terminals have their respective functions, and are assigned for the signals shown in FIG. 8.

As shown in FIG. 8, the signal inputting/outputting unit 61 has a BS terminal as the number 2 terminal, an SDIO terminal as the number 4 terminal, and an SCLK terminal as the number 8 terminal, which receive signals from the host device 10 in accordance with the serial protocol. These number 2, 4 and 8 terminals are physical serial interfaces. These number 2, 4 and 8 terminals are used in accordance with signal form and transfer method common to those for conventional memory card terminals.

The signal inputting/outputting unit 61 has a VSS terminal as the number 1 terminal for the ground, the BS terminal as the number 2 terminal for receiving a bus state signal, a VCC terminal as the number 3 terminal for power supply, the SDIO terminal as the number 4 terminal for inputting/outputting data, an A0 terminal as the number 5 terminal for inputting/outputting audio data, an INS terminal as the number 6 terminal for detecting installation and detachment of the card-shaped memory 30, an A1 terminal as the number 7 terminal for inputting/outputting audio data, the SCLK terminal as the number 8 terminal for receiving a clock signal, a VCC terminal as the number 9 terminal for power supply, and a VSS terminal as the number 10 terminal for the ground.

The memory interface 51 employs the first system whose signal inputting/outputting manner is different from that of the second system, and transmits/receives each of the signals to/from the card-shaped radio communication device 20.

In the communication system 1, the card-shaped radio communication device 20 is mechanically connected to the host device 10, and the card-shaped memory 30 is mechanically connected to the card-shaped radio communication device 20. At this time, the host device 10 and card-shaped radio communication device 20 transmit/receive data between them in accordance with the second system, while the card-shaped radio communication device 20 and card-shaped memory 30 transmit/receive data between them in accordance with the first system.

With the communication system 1, when the host device 10 utilizes the communication function of the card-shaped radio communication device 20, the communication program is read out from the storage unit 52 of the card-shaped memory 30 and sent to the host device 10, and the baseband processing unit 42 of the card-shaped radio communication device 20 controls communication processing by the use of the communication information stored in the card-shaped memory 30. Thus, the host device 10 can communicate with other electric devices included in the radio telecommunication line 100 even though the host device 10 does not have communication function. Furthermore, with the communication system 1, the host device 10 can add its communication function, and can utilize the memory function of the card-shaped memory 30.

Furthermore, with the communication system 1, the host device 10 does not have to have the concave installation portion for using the radio communication function and concave installation portion for using the memory function separately. Thus, reduction in device size and reduction in production cost can be realized.

Furthermore, with the communication system 1, the host device 10 can be provided with the radio communication function and memory function from outside. Thus, the function owned by the host device 10 can be reduced.

Furthermore, with the communication system 1, other users can perform communication using the communication function of the card-shaped radio communication device 20 by exchanging the card-shaped memory 30 installed to the card-shaped radio communication device 20.

Furthermore, with the communication system 1, when performing radio communication, the communication application program does not have to be installed to the host device 10 by means of a CD-ROM or by way of the network, since the card-shaped radio communication device 20 and card-shaped memory 30 have the communication function and memory function for storing the application program to utilize the communication function. Thus, the convenience of the host device 10 will be improved.

In the above-described embodiment, the card-shaped radio communication device 20 has the radio communication function, and the card-shaped memory 30 has the memory function. On the other hand, a card-shaped function device having the memory function as well as radio communication function may be installed to the host device 10.

Furthermore, in the above-described embodiment, only one memory card can be installed to the card-shaped radio communication device 20. On the other hand, plural memory cards may be installed to the card-shaped radio communication device 20. In this case, performing radio communication with other users can be easily realized by storing the communication application program and communication information in different memory cards.

Furthermore, the storage unit 52 of the card-shaped memory 30 may be a ROM (Read Only Memory). The storage unit 52 stores the communication application program which will be used when the card-shaped radio communication device 20 is installed to the host device 10. On detecting a signal indicating that the card-shaped radio communication device 20 is installed to the host device 10, the card-shaped memory 30 loads the application program to the host device 10 via the card-shaped radio communication device 20. Thus, the function owned by the host device 10 can be reduced.

Furthermore, the storage unit 52 of the card-shaped memory 30 may store a program for updating the function of the host device 10. Thus, the function of the host device 10 can be updated via the card-shaped radio communication device 20 by installing the card-shaped memory 30 to the card-shaped radio communication device 20.

What is claimed is:

1. A communication device, comprising:
a first connection means for transmitting/receiving data to/from a first electronic device which has a storage unit having at least communication information related to communication using a radio communication network stored therein in accordance with a first system;
a second connection means for transmitting/receiving data to/from a second electronic device in accordance with a second system;
a communication control instruction reception means for receiving communication control instructions sent from the second electronic device via the second connection means;
a first communication information extraction means for extracting and storing first communication information necessary for a radio communication means from the data received via the first connection means; and
a radio communication means for performing communication between the second electronic device and other electric devices included in the radio communication network by the use of the first communication information extracted by the first communication information extraction means.

2. The communication device as set forth in claim 1, further comprising:
a power reception means for receiving power supplied from the second electronic device via the second connection means.

3. The communication device as set forth in claim 1, further comprising:
a power supply means for supplying power to the first electronic device via the first connection means.

4. The communication device as set forth in claim 1, wherein the second system is the PCMCIA standard.

5. The communication device as set forth in claim 1, wherein the first system is the Compact Flash standard, Memory Stick standard, Smart Media standard, or SD card standard.

6. The communication device as set forth in claim 1, wherein the first connection means and the second connection means consist of different terminals.

7. The communication device as set forth in claim 1, wherein the first communication information is necessary in making connections with other electric devices, and is address information of other electric devices and/or authentication information for performing authentication with other electric devices.

8. The communication device as set forth in claim 1, wherein the first communication information extraction means extracts the first communication information by identifying the file type of the data received via the first connection means.

9. The communication device as set forth in claim 1, further comprising:
a second communication information extraction means for extracting second communication information necessary for the second electronic device in performing communication from the data received via the first connection means,
wherein the second communication information extracted by the second communication information extraction means is sent to the second electronic device via the second connection means in accordance with the communication control instructions received by the communication control instruction reception means.

10. The communication device as set forth in claim 9, wherein the second communication information is necessary in having accesses to service from other electric devices, and is user name information and/or password information.

11. The communication device as set forth in claim 1, further comprising:
a first data format converting means for converting the data received via the first connection means in accordance with the first system to data based on the second system; and
a second data format converting means for converting the data received via the second connection means in accordance with the second system to data based on the first system.

12. The communication device as set forth in claim 11, further comprising:
a communication application program extraction means for extracting a communication application program necessary for the second electronic device in performing communication using the radio communication network from the data received via the first connection means,
wherein, in accordance with the communication control instructions sent from the second electronic device and received by the communication control instruction reception means, the communication application program extracted by the communication application program extraction means is converted to data based on the second system by the first data format converting means, and sent to the second electronic device via the second connection means.
